(19) United States
(12) Patent Application Publication
(10) Pub. No.: US 2009/0027493 A1
(43) Pub. Date: Jan. 29, 2009

(54) Method and device for security in public places

(76) Inventors: Ahron Amar, Haifa (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/880,504

(22) Filed: Jul. 24, 2007

(51) Int. Cl. H04N 7/18

(52) U.S. Cl. 348/77; 348/159; 348/207.1

(57) ABSTRACT

Security system for public places controlled remotely, manually and by a computer program, using cameras and various weapons. Using amongst other methods of crisis identification; facial recognition, behavior recognition and sound recognition. Methods to neutralize the danger of suspect attackers. Useable in public buildings, at public gatherings, on public transport and the like.

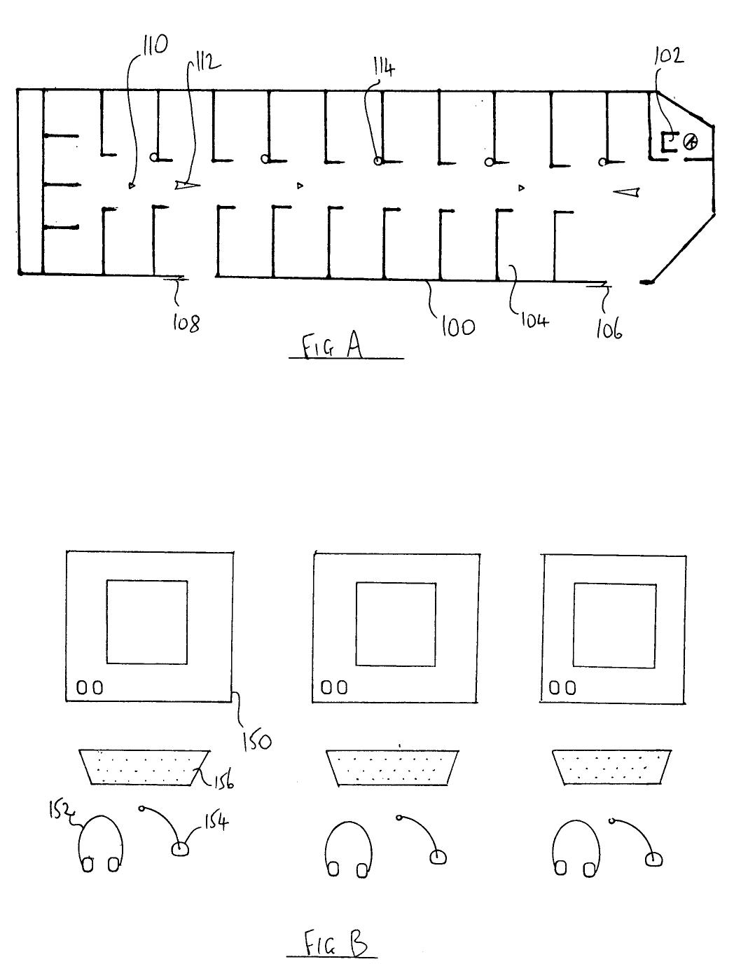

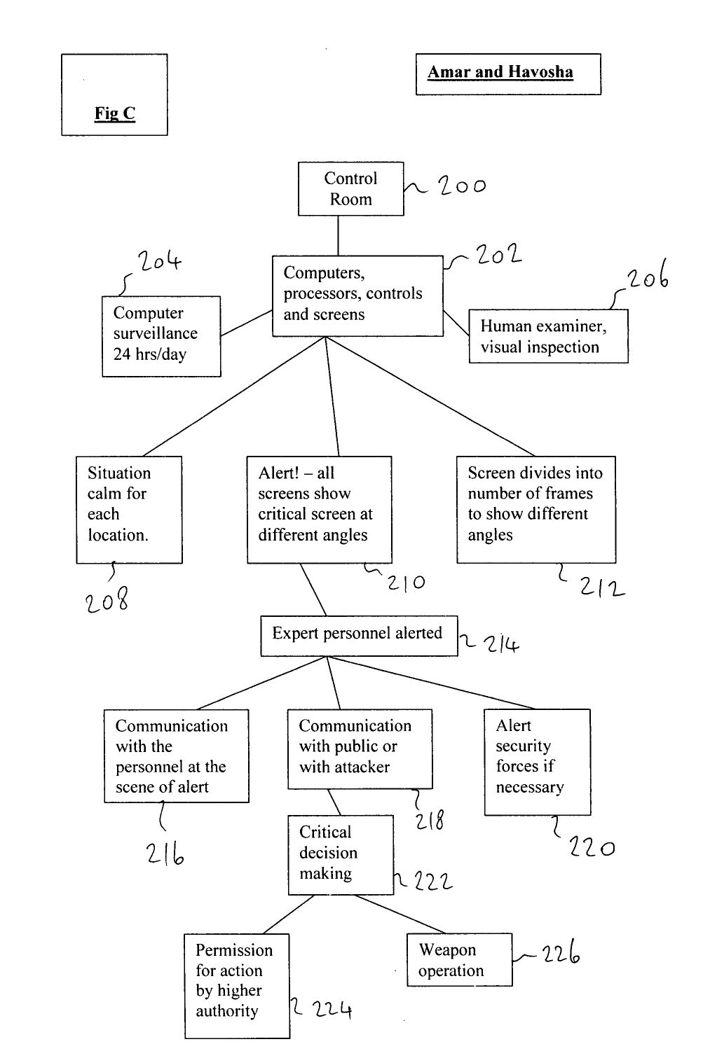

### TECHNICAL FIELD

This invention is in the field of security of public places for example banks, public transport, hotels, buildings of legislation, border controls, cash machines, gatherings of the public in open places and other sensitive situations where it is anticipated that terrorists or robbers and the like, could attack. This invention reveals a method to automate the surveillance of people entering public places and taking action in real-time to prevent the attacker achieving his target. The invention uses high resolution video cameras, communication with security headquarters, identification of suspected persons, prevention of entry where possible and neutralizing the intended actions of suspected persons with minimum risk to others in the area.

### BACKGROUND ART

The current situation is that security in public places, if addressed at all, is still largely carried out manually. This usually involves a person or persons trained to identify the more common signs that are visually observable on the face or body movements of a potential attacker. Verbal contact is also used to evaluate the compatibility of a person with the public expected to be present at such places. Sometimes hand held or free standing metal detectors are employed to detect the presence of metal objects on a person, who is then asked to identify or isolate a metal object for inspection. This close proximity person to person inspection and communication is dangerous for those involved and those in the vicinity, if the suspect is in fact intending to harm. Often the proprietors employ a minimum security arrangement to cover themselves with their insurance companies but those involved know (including the potential attackers) that the arrangement is more of a facade than a real protection.

Any cause for suspicion requires the security persons on site taking such action as they feel justified, subject to the training they have received. They have to take into account many factors like the proximity and danger to innocent people in the area, the degree of certainty that the suspected person presents a real danger and methods at their disposal to neutralize the danger.

For the most part these security personnel are trained minimally and do the best job possible in the circumstances. They have to make real-time split-second life and death decisions, by themselves in the centre of the action.

Often these security persons have to deal with attackers who are well trained over significant periods of time and have strong motivation to succeed in their mission. The attacker often has prior knowledge of the place he intends to attack, has alternative plans prepared if the first plan is not possible and he comes mentally prepared to attack. The security persons are expected to be anticipating an attack but it is hard to keep up a state of alert for long periods of time, namely days, months and years when there is no sign of danger. If they identify a person as a potential attacker, they will usually be in a state of nervousness, if not panic, more so than the attacker.

This invention comes to take some of the heavy responsibility away from the individual security guard and combine high level technology with high level security personnel who, with the aid of the technology, will be better equipped and better qualified to make real-time decisions and take real-time and effective action against potential attackers.

### DISCLOSURE OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

This invention includes the strategic placing of high resolution video cameras in places that are camouflaged from vision. The actual position of this and other equipment will vary depending on the type of building, vehicle, airplane or other premises. For example, the cameras in a public bus could be inside the vertical steadying handles or in the underside of the overhead luggage hold. In a bank these cameras could be camouflaged in the ceiling construction together with the smoke alarms and water sprinklers. The main factor being that, together, these cameras cover all possible areas where people could be, in the place in question and the surrounding area. Wherever the cameras and weapons are placed they would be camouflaged from sight and protected from interference.

These cameras would be connected by land lines or wirelessly to a central location that would monitor the films recorded. The routine monitoring would be for the most part automatic and computer controlled. The computer monitoring would include analysis of peoples' behavior, facial expression, unusual movements and the like. Suspect noise, words or volume could also alert the computer program to warn the trained personnel to focus in on the events at that site. Where possible, analysis of other more intricate factors like the heart beat rate or pupil dilation could be monitored and displayed on a sub-screen. As soon as the computers indicate that a person was behaving in a suspicious way, the well trained personnel preferably police or army personnel, would personally view and analyze the situation. The monitoring screens would focus on this location. They would continue to receive information from the computers via the cameras. They would be able to see and hear all that transpired at the scene. They would be able to see the centre of the action from different angles to increase the amount of information at their disposal so that if and when they have to take action, they will have maximum information to help make the best decision in the circumstances.

When such action is called for, this invention provides for that action to be taken by professionals in objective analysis and taking maximum relevant factors into account. Hidden in the walls, ceiling, floor and other appropriate places, for example, in the upholstery of seats of an airplane, train or bus, would be appropriate weapons to handle a dangerous or potential situation. Such weapons could be operated from the control room. They could also be operable by personnel on site with or without instruction from the headquarters.

Examples of relevant weaponry would be pistols or sub-machine guns with regular bullets, rubber and other special bullets, tear gas, sleep inducers causing immediate unconsciousness and other methods of rendering the attackers powerless.

These weapons would be placed in such positions as would reduce the risk of injury to the innocent bystanders to a minimum. The weapons would be aimed with the aid of the cameras on site and would be able to show to those operating the system, the line of fire to the target. Laser beams could be used to show lines of fire. More than one weapon could be fired at the same time or in close proximity to each other, all depending on the circumstances of each situation. As soon as the suspect is identified as being potentially dangerous then those qualified in the control room could make the decision to neutralize the suspect with the appropriate weapon, given all the circumstances at the scene. If higher authority authorization were required this would be obtained prior to action.

Verbal communication would be possible with certain persons at the scene, for example, in a bank with the staff or in a bus with the driver, in order to gain further relevant information. Loudspeaker communication could be possible from the control room to those at the scene of action. This could be used to give instructions privately to personnel involved at the site, to the public over loudspeakers or to communicate with the attackers. There could be a two-way conversation with the control room.

The control over the premises could include control of the lights, doors, locks, alarms, and any other equipment capable of being operated electronically from a remote position.

Another optional possibility could be for the cameras and weapons to be held in and operated from one device. One control room could be in control of many different premises each one a distance from the other.

### BRIEF DESCRIPTION OF THE DRAWINGS

The accompanying drawings, which are incorporated in and form a part of this specification, illustrate embodiments of the invention and, together with the description, serve to explain, by way of example only, the principles of the invention:

FIG. A is a schematic depiction of the plan view of a bus.

FIG. B is a schematic depiction of a control room headquarters.

FIG. C is a flowchart showing various options and stages associated with this invention

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

FIG. A shows the plan view of a bus 100. The driver 102 sits at the front off side of the bus and the passengers sit on the seats 104. The front door 106 and back door 108 are situated on the near side of bus 100. The cameras 110 could be integrated into the ceiling with a weapon 112 capable of aiming and firing in all directions and angles. An alternative positioning of the cameras and/or the weapons could be integrated in the stabilizing poles 114 often installed next to every other seat in one of the two rows of seats.

FIG. B shows some of the equipment in a control room headquarters. There would be a number of screens 150 attached to the central computers. Headphones 152 and a micro-phone 154 could be available for communication purposes. The keyboard 156 would be used to give instruction to the computer program that controls and operates all the features of this invention, including operating the weapons.

FIG. C is a flowchart showing various options and stages of operation associated with this invention. The control room 200 is the headquarters and operation room for the premises and vehicles protected by this system. The computers 202 including the software programs, processors, screens and control panels would all be situated for the efficient operation of the system.

The cameras 204 would be filming twenty-four hours a day. The computers would constantly analyze this filming to search for the first signs of suspicious behavior. For example, nervous actions, high pulse rate and unusual handling of packages could be constantly monitored. The cameras optionally also could show content of closed packages similar to the X ray filming but by a method not harmful to the persons in the area.

In addition an examiner 206 could check visually to ensure nothing suspicious was happening nor that someone was behaving suspiciously in each of the premises being monitored.

In times of calm 208 each screen could show a different location or alternatively, the screen could swap from one location to another.

In times of alert 210 all screens would automatically show scenes of the critical happening from various different angles. Alternatively one screen could split into a number of scenes 212 each showing a different angle of the critical focus and its surroundings. Cameras in other locations would continue to operate normally, sending their films to the computer 202 for constant analyzes.

As soon as an alert was detected by the computers 202 or the examiner 206, the personnel 214 specially trained for such work would examine the findings. They would have the training and authority to control the situation. They could communicate 216 with the personnel at the scene and optionally speak over a loudspeaker 218 to give instructions to the public or to the attacker. If necessary the security forces could be called to the scene 220.

The expert personnel 214 who would probably be from the police or army, would take into account all relevant factors and make the critical decision 222 whether to neutralize the attacker and by which method. Where the law requires or according to the police or army procedural rules, permission for action 224 could be sought.

If all the relevant conditions are met, a weapon could be fired 226 to neutralize the attacker. At all times the laser-beam would show if any innocent person was in the line of fire.

What is claimed:

1. A method and device for security in public places comprising,
a. at least one computer, at least one software program to carry out the features of this claim that are operable by a computer, at least one monitoring screen and accessories thereto in a remote control-room for recording and analyzing videoed people,
b. at least one camera and at least one weapon in premises being protected,
c. a means to communicate between the said control and the said protected premises,
d. a means for surveillance cameras to detect and analyze suspect behavior including one or more of the following list but not limited only to these factors namely suspect behavior, noise, noise level, speech, speech volume, facial expression, heart pulse and eye dilation,
e. a means to neutralize a suspect person or suspect inanimate object including one or more of the following list but not limited only to these neutralizing methods namely bullets to kill, bullets to injure, tear gas, sleep inducing substance, bright light and laser beam,
f. a means to control electrically operated functions at and around the said protected premises including one or more of the following list but not limited only to these functions namely lights, doors, gates, locks, siren, air conditioning, loudspeakers, microphones and sprinklers, whereby suspicious people or circumstances are detected and action taken to neutralize danger.

2. A method and device for security in public places as claimed in claim 1 wherein the said communication is between the control and the said cameras.

3. A method and device for security in public places as claimed in claim 1 wherein the said communication is between the control and the said weapons.

4. A method and device for security in public places as claimed in claim 1 wherein the said communication is between the control and people privately at the said public places, including two way communication.

5. A method and device for security in public places as claimed in claim 1 wherein the said communication is between the control and people publicly at the said public places, including two way communication.

6. A method and device for security in public places as claimed in claim 1 wherein the said cameras surveillance is recorded.

7. A method and device for security in public places as claimed in claim 1 wherein the said cameras are placed at different locations to be able to film a site at the said public place from more than one angle.

8. A method and device for security in public places as claimed in claim 1 wherein the said cameras and their location are camouflaged.

9. A method and device for security in public places as claimed in claim 1 wherein the said weapons and their location are camouflaged.

10. A method and device for security in public places as claimed in claim 1 wherein the said weapons are controlled and operated from the said public places.

11. A method and device for security in public places as claimed in claim 1 wherein the said public places include at least one of but not limited to the following namely shops, offices, banks, hotels, wedding halls, streets, buses, trains and airplanes,

12. A method and device for security in public places comprising,
a. at least one computer to carry out the features of this claim that are operable by a computer in a control-room for recording and analyzing videoed people in the said public places,
b. at least one camera and at least one weapon in premises being protected,
c. a means to communicate between the said control and the said protected premises,
d. a means for surveillance cameras to detect and analyze suspect circumstances,
e. a means to neutralize a suspect person or suspect inanimate object,
f. a means to control electrically operated functions at and around the said protected premises, whereby suspicious people or circumstances are detected and action taken to neutralize danger.

13. A method and device for security in public places as claimed in claim 12 wherein the said control room is remote from the said public places.

14. A method and device for security in public places as claimed in claim 12 wherein the said suspect circumstances include suspect behavior, noise, noise level, speech, speech volume, facial expression, heart pulse and eye dilation.

15. A method and device for security in public places as claimed in claim 12 wherein the said weapons include bullets to kill, bullets to injure, tear gas, sleep inducing substance, bright light and laser beam.

16. A method and device for security in public places as claimed in claim 12 wherein the said electrically operated functions include lights, doors, gates, locks, siren, air conditioning, loudspeakers, microphones and sprinklers.

17. A method and device for security in public places as claimed in claim 12 wherein the said communication is two way.

18. A method and device for security in public places as claimed in claim 12 wherein the said cameras surveillance is recorded.

19. A method and device for security in public places as claimed in claim 12 wherein the said weapons are controlled and operated from the said public places.

20. A method and device for security in public places as claimed in claim 1 wherein the said cameras and their location and the said weapons and their location are camouflaged.
